(19) United States
(12) Patent Application Publication
(10) Pub. No.: US 2026/0213604 A1
(43) Pub. Date: Jul. 23, 2026

(54) ROTARY ELECTRIC MACHINE, A POWERTRAIN ASSEMBLEY AND AN ELECTRIFIED VEHICLE

(71) Applicant: VALEO POWERTRAIN (NANJING) CO., LTD., Nanjing (CN)

(72) Inventors: Yejin JIN, Shanghai (CN); Kai CHEN, Shanghai (CN); Guoqiang SUN, Shanghai (CN)

(73) Assignee: VALEO POWERTRAIN (NANJING) CO., LTD., Nanjing (CN)

(21) Appl. No.: 19/568,439

(22) Filed: Mar. 16, 2026

Related U.S. Application Data
(63) Continuation of application No. 18/044,282, filed on Sep. 1, 2021, now Pat. No. 12,603,540.

(30) Foreign Application Priority Data
Sep. 11, 2020 (CN) 202010953306.4

(51) Int. Cl. H02K 5/20; H02K 9/19

(52) U.S. Cl. CPC H02K 5/203; H02K 9/19

(57) ABSTRACT

A rotary electric machine includes a rotor configured for coupling with a rotary shaft and a stator configured for surrounding the rotor, the stator includes a stator body and stator end windings which extend from axial ends of the stator body. The rotary electric machine further includes a housing configured for receiving the stator and rotor, the housing includes a fluid distributing chamber provided along an inner surface of the housing for being communicated with a plurality of fluid channels so as to distribute the fluid to flow through outer surfaces of the stator body and stator end windings when the stator is inserted into the housing. The present disclosure further relates to a powertrain assembly and an electrified vehicle including the rotary electric machine.

### CROSS-REFERENCE TO RELATED APPLICATIONS

This application is a continuation of U.S. application Ser. No. 18/044,282 filed Mar. 7, 2023, the entire contents of which is incorporated herein by reference. U.S. application Ser. 18/044,282 is a 371 of International Application No. PCT/CN 2021/115996 filed Sep. 1, 2021, and claims the benefit of priority from prior Chinese Application No. 202010953306.4 filed Sep. 11, 2020.

### FIELD OF THE INVENTION

Embodiments of the present disclosure relate generally to a rotary electric machine, a powertrain assembly and an electrified vehicle comprising the rotary electric machine.

### BACKGROUND OF THE INVENTION

The trend towards designing and building fuel efficient, low emission vehicles has increased dramatically, this trend driven by concerns over the environment as well as increasing fuel costs. At the forefront of this trend has been the development of electrified vehicles, such as BEV, HEV, PHEV, Range extended EV, Fuel Cell etc., electrified vehicles that combine a relatively efficient combustion engine with an electric drive motor. Electrified vehicles can include components, particularly the rotary electric machine used in the powertrain system, that needs appropriate cooling.

Therefore, it would be desirable if any improvements on the cooling design for the rotary electric machine used in the powertrain system for an electrified vehicle could be provided at least with simple configuration, high efficiency and low cost.

### SUMMARY OF THE INVENTION

Aspects and advantages of the invention will be set forth in part in the following description, or may be obvious from the description, or may be learned through practice of the invention.

In accordance with one aspect disclosed herein, a rotary electric machine is provided. The rotary electric machine comprises a rotor configured for coupling with a rotary shaft and a stator configured for surrounding the rotor, the stator includes a stator body and stator end windings which extend from axial ends of the stator body. The rotary electric machine further comprises a housing configured for receiving the stator and rotor, the housing includes a fluid distributing chamber provided along an inner surface of the housing for being communicated with a plurality of fluid channels so as to distribute the fluid to flow through outer surfaces of the stator body and stator end windings when the stator is inserted into the housing.

In accordance with another aspect disclosed herein, a powertrain assembly comprising the rotary electric machine according to the above described is provided.

In accordance with another aspect disclosed herein, an electrified vehicle comprising the rotary electric machine according to the above described is provided.

These and other features, aspects, and advantages of the present disclosure will become better understood with reference to the following detailed description. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic view of a rotary electric machine with a stator in accordance with an exemplary aspect of the present disclosure;

FIG. 2 is a schematic view of the rotary electric machine in accordance with an exemplary aspect of the present disclosure, generally showing one exemplary configuration of fluid distributing chamber and fluid channels between the housing and the stator;

FIG. 3 is a schematic view of a housing of the rotary electric machine in accordance with an exemplary aspect of the present disclosure, showing one exemplary configuration of the annular groove, slots and recesses provided on the housing; and

FIG. 4 is a schematic view of the rotary electric machine with a stator in accordance with another exemplary aspect of the present disclosure, showing one exemplary configuration of the recesses provided on the stator.

### DETAILED DESCRIPTION OF THE INVENTION

Reference will now be made to in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “a”, “an” and “the” are intended to mean that there are one or more of the elements unless the context clearly dictates otherwise. The terms “comprising”, “including” and “having” are intended to be inclusive and mean that there may be additional elements other than the listed elements. The terms “first” and “second” may be used interchangeably to distinguish one component from another and are not intended to signify location or importance of individual components.

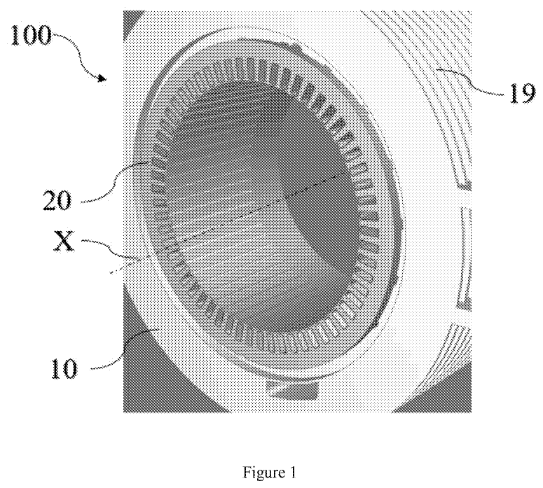

Referring now to the drawings, wherein identical numerals indicate the same elements throughout the figures, FIG. 1 shows a rotary electric machine 100 in accordance with one embodiment of the present disclosure. The rotary electric machine 100 may be in the form of an alternator, an electric motor or a reversible electric machine that can operate in an alternator mode and in an electric motor mode. The rotary electric machine 100 comprises a stator 20 surrounding a rotor (not shown). The rotor may be coupling with a driving shaft (not shown) rotating around an axis X.

The rotary electric machine 100 further comprises a housing 10 for receiving the stator 20 and rotor. A plurality of cooling fins 19 are provided on the outer surface of the housing 10 for dissipating the heat towards the outside of the rotary electric machine 100. The cooling fins 19 allow to increase the outer surface of the housing 10 and thus promote the heat dissipation to the outside of the electric machine 100 via the housing 10. The entire outer surface of the housing 10 may carry cooling fins. The cooling fins may be arranged in rows, and a pitch, constant or not, may exist between two adjacent rows. Theses rows may or may or all have the same orientation. For the embodiment depicted, particularly, each of the cooling fins 19 are circumferentially arranged on the outer surface of the housing 10, and are basically parallel extending from the outer surface of the housing 10.

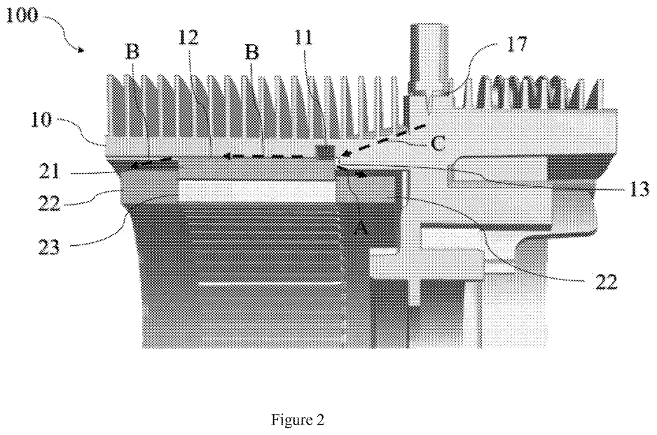

Referring to FIG. 2, the stator 20 comprises a stator body 21 formed by a stack of iron sheets. The stator 20 further comprises end windings 22 extending from the axial ends 23 of the stator 20. Moreover, as can be seen in FIG. 2, the rotary electric machine 100 may be cooled by means of a cooling fluid whose flow paths are shown as arrows A, B and C between the housing 10 and the stator 20. The rotary electric machine 100 is configured such that cooling fluid entering the housing 10 through a single fluid inlet 17 is distributed for direct cooling of the stator 20. Direct cooling of the stator 20 results in lower operating temperatures and higher motor efficiency.

Still referring to FIG. 2, a fluid distributing chamber 11 is provided between an inner surface of the housing 10 and an outer surface of the stator 20, and in fluid communication with the single fluid inlet 17. A plurality of fluid channels 12, 13 are also provided between the inner surface of the housing 10 and the outer surface of the stator 20, and in fluid communication with the fluid distributing chamber 11. Thus, cooling fluid may flow into the fluid distributing chamber 11 from the single inlet 17 according to the flow path of arrow C, further into the fluid channels 12, 13 according to the flow paths of arrows A and B, so that the cooling fluid may flow through the entire outer surface of the stator 20.

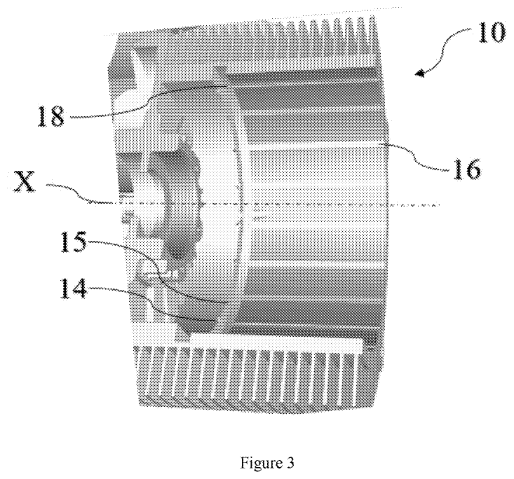

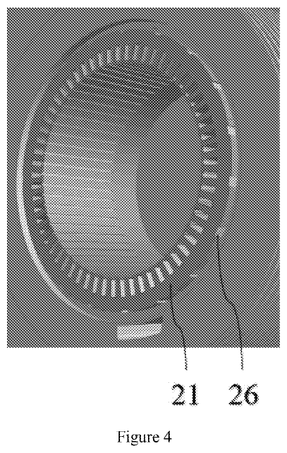

Referring to FIGS. 2, 3 and 4, the plurality of fluid channels comprise several axial cooling channels 12 which are formed by recesses 16, 26 arranged between the stator body 21 and the housing 10, so that cooling fluid may flow into such axial cooling channels 12 from the fluid distributing chamber 11 according to the flow path of arrows B. In one embodiment, the recesses 16 may be circumferentially spaced and provided onto the inner surface of the housing 10, as shown in FIG. 3. In one embodiment, the recesses 26 may be circumferentially spaced and provided onto the outer surface of the stator body 21, as show in FIG. 4. In one embodiment, the recesses may be arranged on both the inner surface of the housing 10 and the outer surface of the stator body 21. By means of these several axial cooling channels 12, cooling fluid from the fluid distributing chamber 11 may flow through the outer surface of the stator body 21 and one end winding 22 of the stator.

Referring to FIGS. 2 and 3, the plurality of fluid channels comprise another several axial cooling channels 13 which are formed by slots 14 provided on the housing 10 and by one outer surface of the stator 20, so that cooling fluid may flow into such another axial cooling channels 13 from the fluid distributing chamber 11 according to the flow path of arrow A which is opposite to the flow path of arrows B in the axial direction. By means of these another several axial cooling channels 13, cooling fluid also from the fluid distributing chamber 11 may flow to the other end winding 22 of the stator.

Still referring to FIGS. 2 and 3, the fluid distributing chamber 11 is disposed where the stator 20, especially the stator body 21, abuts against the housing 10 in the axial direction when the stator 20 is installed in the housing 10. The fluid distributing chamber 11 comprises a stopper surface 15 provided with the housing 10, the stopper surface 15 extends from the inner surface of the housing 10 towards to the axis X so as to limit the axial movement of the stator 20. The slots 14, forming the another several axial cooling channels 13 for directing the cooling fluid to flow to the other end winding 22 of the stator, are circumferentially spaced and provided by the edge of the stopper surface 15.

An annular groove 18 is provided with the inner surface of the housing 10 for surrounding the stator in a circumferential direction. The annular groove 18 forms one part of the fluid distributing chamber 11 and is in fluid communication with both the slots 14 and the recesses 16, 26. In one embodiment, the stopper surface 15 is one of the sides of the annular groove 18.

With the configuration as described above, the cooling circuit using a fluid distributing chamber 11 forming by the housing 10 and by the stator 20 will be automatically built in when the stator 20 is inserted into the housing 10, and the entire outer surface of the stator 20 could be directly cooled by the cooling fluid flowing through in such cooling circuit.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A rotary electric machine, comprising
a rotor configured for coupling with a rotary shaft;
a stator configured for surrounding the rotor, the stator comprising a stator body and stator end windings extending from axial ends of the stator body; and
a housing configured for receiving the stator and rotor;
wherein a fluid distributing chamber provided along an inner surface of the housing for being communicated with a plurality of fluid channels so as to distribute the fluid to flow through outer surfaces of the stator body and stator end windings when the stator is inserted into the housing;
the fluid distributing chamber is disposed where the stator abuts against the housing in an axial direction and is formed by one inner surface of the housing and by one outer surface of the stator.
